(19) United States
(12) Patent Application Publication
(10) Pub. No.: US 2007/0282469 A1
(43) Pub. Date: Dec. 6, 2007

(54) Data processing unit and data processing method

(75) Inventor: Norikatsu Kataoka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/806,328

(22) Filed: May 31, 2007

(30) Foreign Application Priority Data
May 31, 2006 (JP) 2006-151579

(51) Int. Cl. G05B 15/00

(52) U.S. Cl. 700/83

(57) ABSTRACT

There are provided a data processing unit and a data processing method capable of reducing a burden involved in packaging and control, and of presenting multiple types of data blocks having different viewpoints with a simple operation. A correlating means correlates objects with multiple types of data blocks having different viewpoints relative to the objects. A selection screen displaying means displays a selection screen so as to accept selection of the viewpoints relative to the objects. A data presenting means acquires data blocks correlated with the objects in respect of the viewpoint selected on the selection screen via the correlating means, thereby presenting the data blocks.

### FIELD OF THE INVENTION

The invention relates to data-processing equipment (hereinafter referred to as a data processing unit) and a data processing method for handling multiple types of data blocks.

### BACKGROUND OF THE INVENTION

In a plant control system for executing a control of a plant, graphic screens are displayed on terminal units for monitoring facilities of the plant. FIG. 6 exemplifies a graphic screen on which field apparatuses and connection paths.

Parameter values 71 of the field apparatuses that are necessary for operating the plant are displayed on the graphic screen. An operator specifies range of facilities of the plant and causes the graphic screen to be displayed within specified range, thereby executing an operation such as monitoring the parameter values, inputting and changing of the parameter values, and so forth.

There was available, for example, as disclosed in JP 2003-36114A, a human-machine interface device for blending product viewpoints with product facility viewpoints.

However, the graphic screen as mentioned above is limited in an object to use the screen, for example, only data blocks needed for a control operator are displayed. In a plant, separate individual systems have been conventionally introduced for every operation, and in a system specialized in a single operation, a user's need is satisfied. However, there has been recently desired a system capable of handling various operations in unification, and the conventional system becomes difficult to deal with such various operations when utilization of various operations for a field man, a maintenance engineer as well as a control operator come into view.

For instance, in the case of coping with multiple operations by use of a conventional system, it is necessary to prepare graphic screens for every operation, resulting in need for troublesome work involved in packaging. Further, even in the case of introducing or changing one facility, graphic screens having different viewpoints for every operation exist, correcting operations are required for multiple graphic screens, becoming a burden in terms of control.

Further, in the case of unifying systems which are configured for every operation, even in the same facility, procedures to call out the graphic screen of the same facility are different from one another for every system, while in the case of displaying the same facility by switching over the viewpoints, a complicated procedure is needed. Still further, the procedures for switching over the viewpoints become complex, there occurs a problem that the range or viewpoints of facilities, which are displayed as graphic screens, becomes incomprehensible.

### SUMMARY OF THE INVENTION

It is an object of the invention to provide a data processing unit and a data processing method capable of reducing a burden involved in packaging and control, and of presenting multiple types of data blocks having different viewpoints with a simple operation.

The data processing unit for handling multiple types of data blocks of the first aspect of the invention is characterized in comprising a correlating means for correlating objects with multiple types of data blocks having different viewpoints relative to the objects, a selection screen displaying means for displaying a selection screen so as to accept selection of the viewpoints relative to the objects, and a data presenting means for acquiring data blocks correlated with the objects in respect of the viewpoints selected on the selection screen via the correlating means, thereby presenting the data blocks.

According to the data processing unit of the invention, since the objects and the multiple types of data blocks having different viewpoints relative to the objects are correlated with each other, a burden involved in packaging and control can be reduced. Further, since the data blocks correlated with the objects in respect of the viewpoints selected on the selection screen are acquired via the correlating means, thereby presenting the data blocks, the multiple types of data blocks having different viewpoints can be presented with a simple operation.

In the data processing unit, it may further comprise an information processing means for executing information processing on the data blocks presented by the data presenting means.

In the data processing unit, the selection screen may be displayed by the selection screen displaying means while the data blocks are presented by the data presenting means.

In the data processing unit, the selection screen displayed by the selection screen displaying means and a data display screen displayed by the data presenting means may be displayed on the same screen.

In the data processing unit, the data display screen displayed by the data presenting means may display the data blocks within a screen using a common image regardless of the viewpoints.

In the data processing unit, the objects may be objects to be monitored.

The data processing method for handling multiple types of data blocks of the second aspect of the invention is characterized in comprising a step of correlating objects with multiple types of data blocks having different viewpoints relative to the objects, a step of displaying a selection screen so as to accept selection of all the viewpoints relative to the objects, and a step of acquiring data blocks correlated with the objects in respect of the viewpoints selected on the selected screen via the correlation, thereby presenting the data blocks.

According to the data processing method of the invention, since the objects and the multiple types of data blocks having different viewpoints relative to the objects are correlated with each other, a burden involved in packaging and control can be reduced. Further, since the data blocks correlated with the objects in respect of the viewpoints selected on the selection screen are acquired via the correlation, thereby presenting the data blocks, the multiple types of data blocks having different viewpoints can be presented with a simple operation.

In the data processing method, it may further comprise a step of executing information processing on the data blocks presented in the step of presenting the data blocks.

In the data processing method, the selected screen may be displayed in the step of displaying the selected screen while the data blocks are presented in the step of presenting the data blocks.

In the data processing method, the selected screen displayed in the step of displaying the selected screen and a data display screen displayed in the step of presenting the data blocks may be displayed on the same screen.

In the data processing method, the display screen displayed in the step of presenting the data blocks may display the data blocks within a screen using a common image regardless of the viewpoints.

In the data processing method, the objects may be objects to be monitored.

According to the data processing unit of the invention, since the objects and the multiple types of data blocks having different viewpoints relative to the objects are correlated with each other, a burden involved in packaging and control can be reduced. Further, since the data blocks correlated with the objects in respect of the viewpoints selected on the selection screen are acquired via the correlating means, thereby presenting the data blocks, the multiple types of data blocks having different viewpoints can be presented with a simple operation.

According to the data processing method of the invention, since the objects and the multiple types of data blocks having different viewpoints relative to the objects are correlated with each other, a burden involved in packaging and control can be reduced. Further, since the data blocks correlated with the objects in respect of the viewpoints selected on the selection screen are acquired via the correlation, thereby presenting the data blocks, the multiple types of data blocks having different viewpoints can be presented with a simple operation.

### BRIEF DESCRIPTION OF THE DRAWINGS

FIG. 1 is a block diagram showing a configuration of a data processing unit according to an embodiment of the invention;

FIG. 2 is a flowchart showing an operation procedure of the data processing unit according to the embodiment of the invention;

FIG. 3 is a view showing a configuration of a table stored in a correlating means;

FIG. 4 is a view showing a display screen, wherein FIG. 4(A) is a view exemplifying a displayed graphic screen and FIG. 4(B) is a view exemplifying a selection screen;

FIG. 5 is a view showing a display screen in the case where a new viewpoint is selected; and

FIG. 6 is a view showing a display screen in a conventional system.

### PREFERRED EMBODIMENT OF THE INVENTION

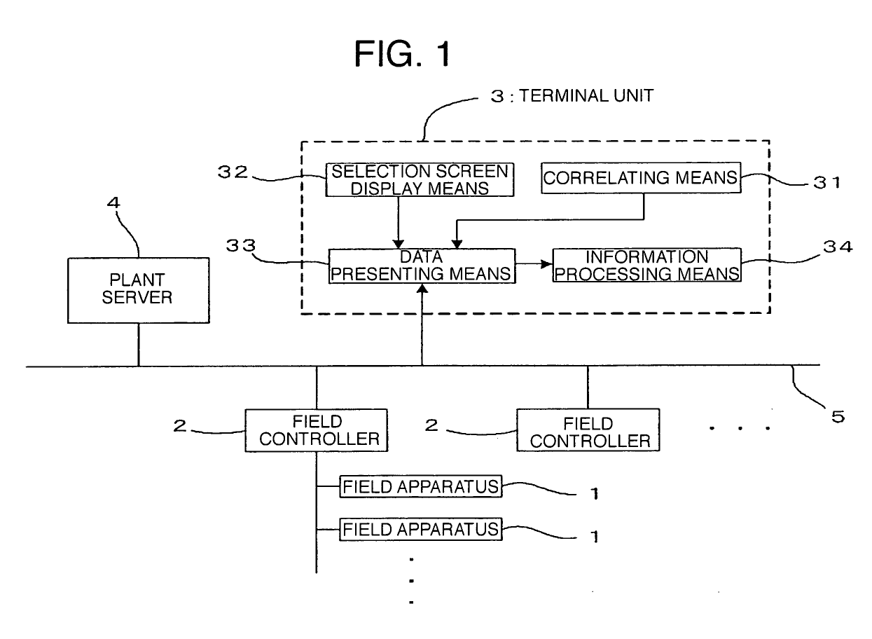

An embodiment of a data processing unit according to the invention is described hereinafter with reference to FIGS. 1 to 5.

FIG. 1 is a block diagram showing a configuration of the data processing unit according to the embodiment of the invention. As shown in FIG. 1, the data processing unit is provided with field controllers 2, 2, . . . for controlling field apparatuses 1, 1, . . . , a terminal unit 3 for monitoring respective facilities of a plant, a plant server 4 for storing various plant information including historical data blocks in the plant. The field controllers 2, 2, . . . , the terminal unit 3 and the plant server 4 are connected to one another via a communication line 5.

The terminal unit 3 comprises a correlating means 31 for correlating the facilities of the plant with multiple tapes of data blocks having different viewpoints relative to the facilities, a selection screen display means 32 for displaying a selection screen for accepting the selection of the viewpoints relative to the facilities, a data presenting means 33 for acquiring data blocks correlated with the facilities in respect of the viewpoints selected on the selection screen via the correlating means 31, and presenting the acquired data blocks, and an information processing means 34 for executing information processing on the data blocks presented by the data presenting means 33.

A user can monitor the facilities of the plant via the terminal unit 3. The user can designate the range of facilities to be monitored by operating the terminal unit 3 whereby graphics showing the facilities within the designated range and necessary data blocks are displayed on a display screen of the terminal unit 3. The user can display data blocks necessary for user's operation by selecting viewpoints corresponding to the user's operation. For example, in the case where the user is an operator, if the user selects the viewpoint corresponding to the operation, data blocks necessary for the operation of the plant are displayed. Likewise, in the case where the user is a maintenance personnel, if the user selects the viewpoint corresponding to the operation of the maintenance personnel, data blocks necessary for the maintenance of the plant are displayed. Further, in the case where data blocks are intended to be displayed from the multiple viewpoints, data blocks corresponding to the respective viewpoints can be sequentially displayed by changing over the viewpoints.

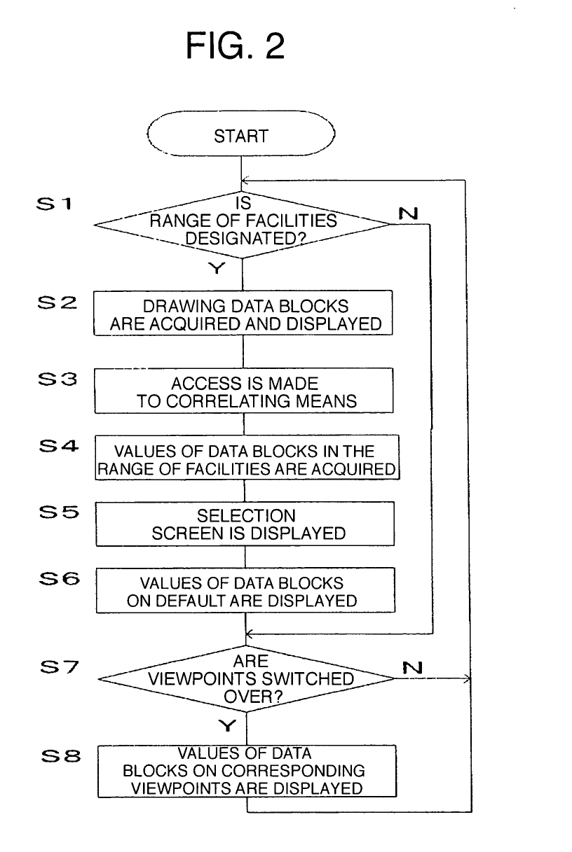

FIG. 2 is a flowchart showing an operation procedure of the data processing unit according to the embodiment of the invention.

In step S1 of FIG. 2, determination is made whether or not the range of facilities is designated by operating the terminal unit 3. If the determination in step S1 is Yes, the operation proceeds to step S2, while if the determination in step S1 is No, the operation skips to step S7.

In step S2, drawing data blocks necessary for displaying graphics are acquired relative to the range of facilities, and the graphics are displayed. The drawing data blocks may be, for example, stored in advance in the terminal unit 3.

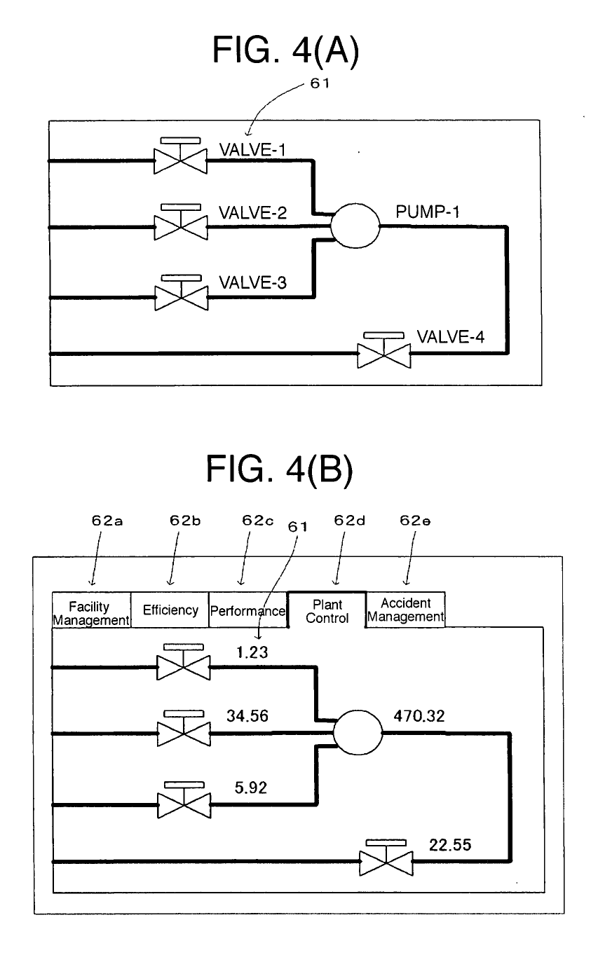

FIG. 4(A) is a view exemplifying displayed graphics. As shown in FIG. 4(A), within the range of the designated facilities, for example, field apparatuses and connection paths are displayed. Names of the apparatuses are layouted to the displays of the field apparatuses in the graphics. In the case of FIG. 4(A), the layouted name of apparatus (e.g. “valve-1”) is displayed on an area 61 in the vicinity of an area where the apparatus is drawn.

Next in step S3, access is made to the correlating means 31 to specify data blocks corresponding to the designated range of facility.

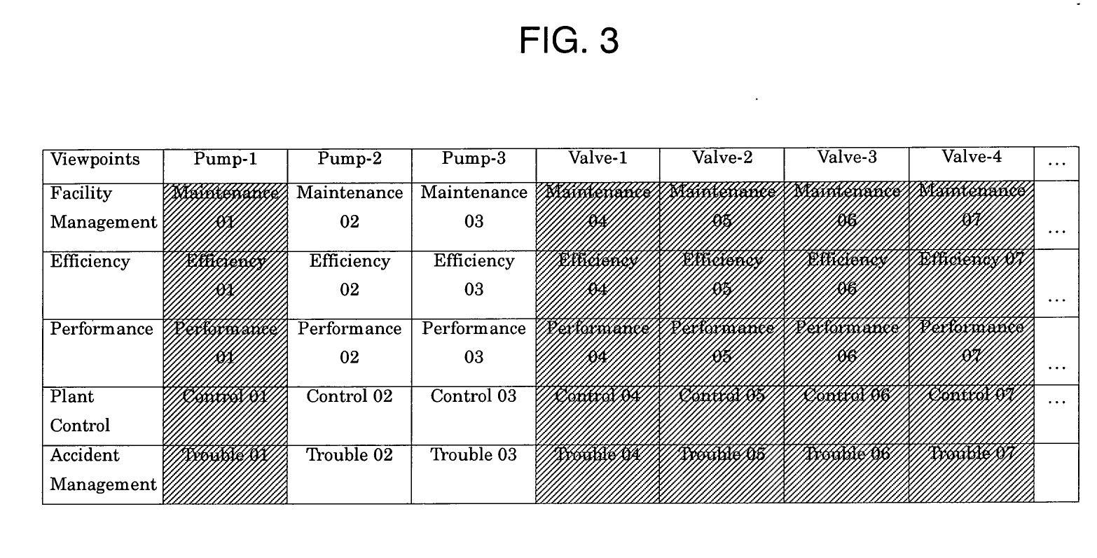

FIG. 3 is a view showing a configuration of a table stored in the correlating means 31. The apparatus (e.g. “valve-1”) and the data blocks on all the viewpoints of the apparatus are defined in this table. In the example of FIG. 3, the viewpoints are provided based on operations, for example, a data block on “facility management” of “valve-1” is “maintenance 04” while a data block on “efficiency” is “efficiency 04”.

For example, in the case where the designated range of facilities is the range of facilities as shown in FIG. 4(A), data blocks on all viewpoints of “valve-1”, “valve-2”, “valve-3”, “valve-4” and “pump-1” are specified as data blocks corresponding to the designated range of facilities. Data blocks as hatched in FIG. 3 correspond thereto.

In step S4, access is made to respective data sources of data blocks specified in step S3, thereby obtaining values of data blocks. Here, the data blocks and addresses of the data sources in which the data blocks are stored are acquired from an address table, and so forth, and access is made to the specified addresses thereof, thereby obtaining necessary values of data blocks. The address table may be, for example, stored in advance in the terminal unit 3.

The data sources are, for example, field controllers 2, 2, . . . and the plant information server 4, and they are varied depending on the types of data blocks.

Next in step S5, the selection screen is displayed on the terminal unit 3 by the selection screen display means 32, and the values of data blocks on the viewpoint designated as default are displayed to superimpose over the selection screen.

FIG. 4(B) is a view exemplifying a selection screen. Tabs 61a to 61e for selecting viewpoints and the graphs screen same as FIG. 4(A) are displayed on the selection screen. Values of data blocks on viewpoints which are now selected are displayed on an area 61 of the graphic screen by the data presenting means 33 (step S6). For example, the value of data block on the “valve-1” is displayed on the area 61. In the case of FIG. 4(B), since “plant control” is specified as a viewpoint of the default, the value (parameter value of the field apparatus) of data block on the viewpoint of “plant control” is displayed on the corresponding area. Further, a state where the tab 62d of the “plant control” is selected is displayed on the selection screen.

The viewpoint of the default may be set for every terminal unit or can be decided in response to user's role that has been recognized at the time of logon or of a user's authentication.

Next in step S7, determination is made whether or not the switching of the viewpoints is directed and if the determination in step S7 is Yes, the operation proceeds to step S8, while if the determination in step S7 is No, the operation reverts to step S1. Meanwhile, in step S7, the switching of the viewpoints is accepted only in the case where the designation of the range of facilities (step S1) has been already accepted, and determination is Yes. If the designation of the range of facilities has not been accepted yet, the determination is always No.

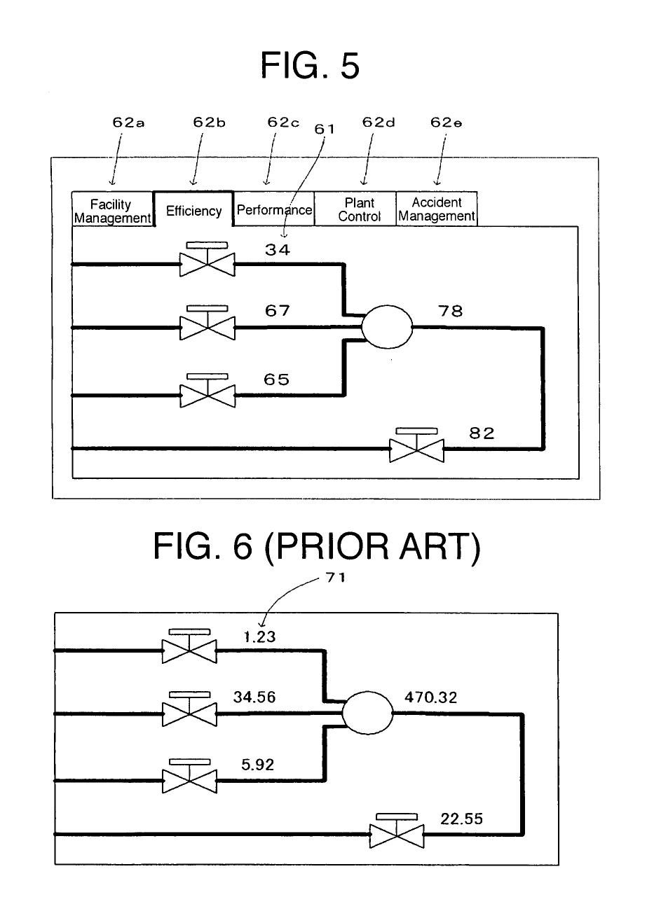

In step S8, the value of data block on the viewpoint which is newly selected in step S7 is displayed on the area 61, and so forth and a state where the tab corresponding to the viewpoint which is newly selected is displayed. For example, as shown in FIG. 5, in the case where “efficiency” is selected as a new viewpoint, the value of data block on “efficiency” is displayed on the area 61, and a state where the tab 62b of “efficiency” is selected is displayed. This screen serves as the selection screen and a next viewpoint can be selected by use of this screen.

Upon completion of execution of the processing in step S8, the operation reverts to step S1.

According to the data processing unit of the present embodiment, various operations on the displayed data blocks can be executed by the user's operation relative to the display screen shown in FIG. 4(B) or FIG. 5. For example, it is possible to direct expansion to other screen in addition to the setting and changing of values of data blocks. Various information processing on these data blocks is executed by the information processing means 34.

With the data processing unit of the present embodiment, constituent elements of the range of facilities displayed on the graphic screen are handled as abstract concepts, and data blocks on multiple viewpoints are correlated with the respective constituent elements. Accordingly, by merely specifying the constituent elements appearing on the graphic screen, data blocks on all the viewpoints can be displayed or handled. Accordingly, an operating burden involved in packaging can be reduced.

Further, in the case where correction to the graphic screen is implemented, the correlation with the data blocks on all the viewpoints is established by the correlating means 31 by merely changing the layout of the constituent elements to be displayed on the screen, a troublesome work is not required for changing the display screens.

With the data processing unit of the present embodiment, since the screen on which the values of data blocks on the selected viewpoints are displayed and the selection screen have commonality, it is possible to clearly determine a state where the designated range of facilities are inspected from which viewpoint, so that excellent visibility and operability can be obtained. Further, the viewpoints can be switched over from the common selection screen, the switching of the viewpoints in the same range of facilities can be made with very ease, and hence there is no possibility that the range of facilities to be displayed are changed inadvertently when the viewpoints are switched over.

According to the embodiment of the invention, values of data blocks on the selected viewpoints on the selection screen are displayed on the screen by the data presenting means 33, a presenting method of data blocks is not limited to the present embodiment. For example, data blocks may be displayed as image or presented by sound.

Further, according to the embodiment of the invention, although the selection of viewpoint by the operation relative to the display screen is accepted, the viewpoints may be selected in advance in response to user's role that has been recognized at the time of logon or of a user's authentication.

Still further, according to the embodiment of the invention, although the same graphic screen has been used for multiple viewpoints, when the viewpoints are switched over, it may be possible to switch to the different screen display. For example, if “plant control” is selected as the viewpoint, the graphic screen shown in FIG. 5 is displayed, while if “facility management” is selected as the viewpoint, a screen showing a maintenance history of the facility may be displayed.

Further, it is to be understood that the invention is not limited in its application to the embodiment described hereinbefore. The invention can be widely applied to a data processing unit and a data processing method for handling multiple types of data blocks.

What is claimed is:

1. A data processing unit for handling multiple types of data blocks comprising:
a correlating means for correlating objects with multiple types of data blocks having different viewpoints relative to the objects;
a selection screen displaying means for displaying a selection screen so as to accept selection of the viewpoints relative to the objects; and
a data presenting means for acquiring data blocks correlated with the objects in respect of the viewpoint selected on the selection screen via the correlating means, thereby presenting the data blocks.

2. The data processing unit according to claim 1, further comprising an information processing means for executing information processing on the data blocks presented by the data presenting means.

3. The data processing unit according to claim 1, wherein the selection screen is displayed by the selection screen displaying means while the data blocks are presented by the data presenting means.

4. The data processing unit according to claim 3, wherein the selection screen displayed by the selection screen displaying means and a data display screen displayed by the data presenting means are displayed on the same screen.

5. The data processing unit according to claim 4, wherein the data display screen displayed by the data presenting means displays the data blocks within a screen using a common image regardless of the viewpoints.

6. The data processing unit according to claim 1, wherein the objects are objects to be monitored.

7. A data processing method for handling multiple types of data blocks comprising:
a step of correlating objects with multiple types of data blocks having different viewpoints relative to the objects;
a step of displaying a selection screen so as to accept selection of all the viewpoints relative to the objects; and
a step of acquiring data blocks correlated with the objects in respect of the viewpoints selected on the selected screen via the correlation, thereby presenting the data blocks.

8. The data processing method according to claim 7, further comprising a step of executing information processing on the data blocks presented in the step of presenting the data blocks.

9. The data processing method according to claim 7, wherein the selected screen is displayed in the step of displaying the selected screen while the data blocks are presented in the step of presenting the data blocks.

10. The data processing method according to claim 7, wherein the selected screen displayed in the step of displaying the selected screen and a data display screen displayed in the step of presenting the data blocks are displayed on the same screen.

11. The data processing method according to claim 10, wherein the display screen displayed in the step of presenting the data blocks displays the data blocks within a screen using a common image regardless of the viewpoints.

12. The data processing method according to claim 7, wherein the objects are objects to be monitored.
